(19) United States
(12) Patent Application Publication
(10) Pub. No.: US 2009/0122339 A1
(43) Pub. Date: May 14, 2009

(54) COMMUNICATION DEVICE CAPABLE OF ORGANIZING DUPLICATED ADDRESS BOOK RECORDS

(75) Inventor: Kuniki NAKAMURA, Gifu-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: BROTHER KOGYO KABUSHIKI KAISHA, Aichi-ken (JP)

(21) Appl. No.: 12/270,331

(22) Filed: Nov. 13, 2008

(30) Foreign Application Priority Data
Nov. 13, 2007 (JP) 2007-294007

(51) Int. Cl. G06F 3/12

(52) U.S. Cl. 358/1.15

(57) ABSTRACT

A communication device includes a storing section, a determining section, and a storage controlling section. The storing section is configured to store a plurality of communication contact data, each communication contact datum including a set of a plurality of data entries identifying a single communication contact. The determining section is configured to determine whether any two or more of the plurality of communication contact data stored in the storing section include common data entries. The storage controlling section is configured to store the set of data entries included in the communication contact data determined to have common data entries in the storing section as a single communication contact datum when the determining section determines that there exists a plurality of communication contact data including common data entries.

### CROSS REFERENCE TO RELATED APPLICATION

This application claims priority from Japanese Patent Application No. 2007-294007 filed Nov. 13, 2007. The entire disclosure of the priority application is incorporated herein by reference in its entirety.

### TECHNICAL FIELD

The present invention relates to a communication device capable of storing a plurality of communication contact records, each configured of a plurality of data entries identifying a communication contact, and a contact data management program capable of executing on a computer in the communication device.

### BACKGROUND

A communication device such as a facsimile device or a telephone device has been conventionally provided with a function for storing a set of data indicating a contact's telephone number, e-mail address, name, and the like (hereinafter referred to as “data entries”) in internal memory as a single communication contact datum (hereinafter referred to as an “address book record”). This type of communication device can also acquire address book records stored in an external storage device, such as the memory of an external communication device. An example of this communication device is disclosed in Japanese patent application No. 2002-135400.

When acquiring address book records from the external storage device, the communication device determines whether any of the address book records acquired from the external storage device has similar content to the address book records currently stored in internal memory. If so, the communication device prompts the user to choose whether to overwrite the address book record in internal memory with the acquired address book record having similar content.

However, in the Japanese patent application No. 2002-135400 described above, when only some of the data entries included in one address book record (for example, only the contact name or telephone number) are identical to data entries in another address book record, both address book records are stored in internal memory as individual records. Consequently, a plurality of address book records having similar data entries is stored in internal memory, needlessly increasing the number of records stored in memory. In other words, the memory is not effectively used for storing address book data. Further, the needless increase in the number of address book records in memory may reduce the convenience in managing and accessing address book data.

### SUMMARY

In view of the foregoing, it is an object of the present invention to provide a communication device capable of efficiently storing address book records already existing in internal memory and address book records acquired from an external storage device. It is another object of the present invention to provide a contact data management program capable of executing on a computer in the communication device.

In order to achieve the above and other objects, the present invention provides a communication device including a storing section, a determining section and a storage control section. The storing section is configured to store a plurality of communication contact data, each communication contact datum including a set of a plurality of data entries identifying a single communication contact. The determining section is configured to determine whether any two or more of the plurality of communication contact data stored in the storing section include common data entries. The storage controlling section is configured to store the set of data entries included in the communication contact data determined to have common data entries in the storing section as a single communication contact datum when the determining section determines that there exists a plurality of communication contact data including common data entries.

According to another aspect of the invention, there is provided a communication device including a first storing section, a second storing section, an acquiring section, a determining section and a storage controlling section. The first storing section is configured to store a plurality of communication contact data, each communication contact datum including a set of a plurality of data entries identifying a single communication contact. The second storing section is externally connected to the communication device, and the acquiring section is configured to acquire the communication contact data stored in the second storing section. The determining section is configured to determine whether any two or more of the plurality of communication contact data acquired by the acquiring section and stored in the first storing section include common data entries. The storage controlling section is configured to store the set of data entries included in the communication contact data determined to have common data entries in the first storing section as a single communication contact datum when the determining section determines that there exists a plurality of communication contact data including common data entries.

According to still another aspect of the invention, there is provided a storage medium storing a contact data management program. The contact data management program has a set of program instructions executable on a computer of a communication device that includes a storing section that is configured to store a plurality of communication contact data, each communication contact data including a set of a plurality of data entries identifying a single communication contact. The set of program instructions includes determining whether any two or more of the plurality of communication contact data stored in the storing section include common data entries, and storing the set of data entries included in the plurality of communication contact data determined to have common data entries in the storing section as a single communication contact datum when it is determined that there exists a plurality of communication contact data including common data entries.

According to further aspect of the invention, there is provided a storage medium storing a contact data management program. The contact data management program has a set of program instructions executable on a computer of a communication device, the communication device including a first storing section and a second storing section. The first storing section is configured to store a plurality of communication contact data, each communication contact data including a set of a plurality of data entries identifying a single communication contact. The second storing section is externally connected to the communication device. The set of program instructions includes acquiring the communication contact data stored in the second storing section, determining whether any two or more of the plurality of communication contact data acquired and stored in the first storing section include common data entries, and storing the set of data entries included in the communication contact data determined to have common data entries in the first storing section as a single communication contact datum when it is determined that there exists a plurality of communication contact data including common data entries.

### BRIEF DESCRIPTION OF THE DRAWINGS

The particular features and advantages of the invention as well as other objects will become apparent from the following description taken in connection with the accompanying drawings, in which:

FIG. 1 is a block diagram showing the internal structure of a multifunction peripheral according to a first embodiment of the present invention;

FIG. 2 is an explanatory diagram showing the configuration of an address book storage area of EEPROM in the multifunction peripheral storing address book records;

FIG. 3 is a flowchart illustrating steps in a process executed by a CPU of the multifunction peripheral according to a contact data management program of the first embodiment;

FIG. 4 is an explanatory diagram showing an Options window for setting a search condition for duplicate data;

FIG. 5 is an explanatory diagram showing an Options window for setting a search condition for duplicate data;

FIG. 6 is an explanatory diagram showing a display screen with a message indicating that no duplicate data exists;

FIG. 7 is an explanatory diagram showing the content of the address book storage area after combining records with duplicate data;

FIG. 8 is an explanatory diagram showing a sample user confirmation window;

FIG. 9 is an explanatory diagram showing another sample user confirmation window;

FIG. 10 is a flowchart illustrating steps in a process executed by the CPU in a user-specified entry process;

FIG. 11 is an explanatory diagram showing a sample user selection window;

FIG. 12 is an explanatory diagram showing a sample selection window for selecting the number of address book records to combine;

FIG. 13 is an explanatory diagram showing a sample selection window for selecting data to combine;

FIG. 14 is an explanatory diagram showing a sample selection window for selecting a name to delete;

FIG. 15 is an explanatory diagram showing a sample selection window for selecting a telephone number to delete;

FIG. 16 is an explanatory diagram showing a sample selection window for selecting an e-mail address to delete;

FIG. 17 is a block diagram showing the internal structure of a multifunction peripheral and a mobile telephone according to a second embodiment of the present invention;

FIG. 18 is an explanatory diagram illustrating an address book record stored in the vCard file format;

FIG. 19 is a flowchart illustrating steps in a process executed by the CPU according to a contact data management program of the second embodiment;

FIG. 20 is an explanatory diagram showing an Options window for indicating whether to combine duplicate data; and

FIG. 21 is a flowchart illustrating steps in a process executed by a CPU of the mobile telephone to transmit address book records.

### DETAILED DESCRIPTION

### (Structure of a Communication Device According to a First Embodiment)

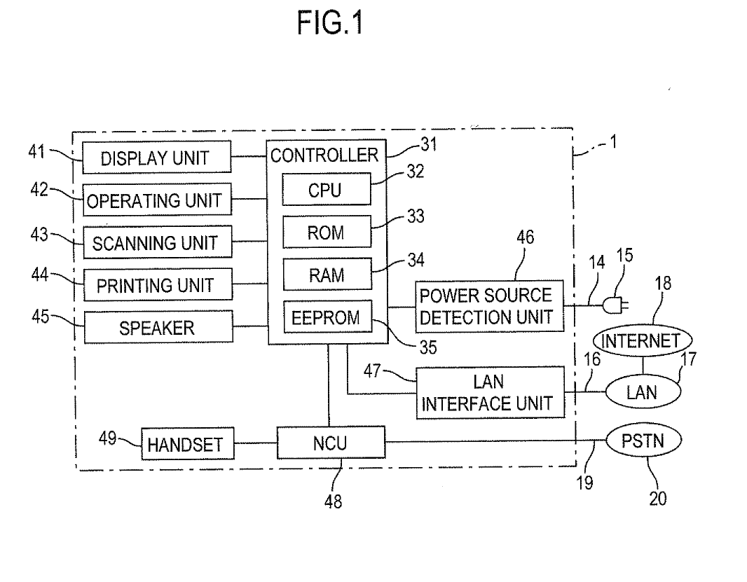

Next, a first preferred embodiment of the present invention will be described while referring to the accompanying drawings. FIG. 1 is a block diagram showing the internal structure of a multifunction peripheral (MFP) 1 serving as a communication device to which the present invention is applied.

The MFP 1 is provided with multiple functions including an inkjet printer function, a scanner function, and a facsimile transmission/reception function to transfer and receive image data, for example. The MFP 1 can function as a printer or scanner when connected to a personal computer, for example, and can also function as a copier when using the scanner function and printer function in combination.

Internally, the MFP 1 includes a controller 31. The controller 31 further includes a CPU 32, a ROM 33, a RAM 34, and an EEPROM 35. The CPU 32, ROM 33, RAM 34, and EEPROM 35 are interconnected via a bus (not shown). The controller 31 is also connected to a display unit 41, an operating unit 42, a scanning unit 43, a printing unit 44, a speaker 45, a power source detection unit 46, a LAN interface unit 47, and a network configuration utility (NCU) 48. The NCU 48 is further connected to a handset 49.

A power connector 15 is connected to the power source detection unit 46 via a power cable 14. A local area network (LAN) 17 is connected to the LAN interface unit 47 via a LAN cable 16, and is also connected to an internet 18 via a router (not shown). However, the LAN interface unit 47 may also be connected to the internet 18 through a wireless LAN rather than the LAN cable 16. In addition, a public switched telephone network (PSTN) 20 is connected to the NCU 48 via a communication cable 19.

The CPU 32 controls the overall operations of the MFP 1. The ROM 33 stores various operational programs executed by the CPU 32, constants used in the various processes, display data to be displayed on the display unit 41, data for the telephone function, and the like. The operational programs include a contact data management program to be described later. The RAM 34 provides among other things a work area for the CPU 32.

The EEPROM 35 stores image data scanned by the scanning unit 43, reception data received according to a communication function described later, and other data. The CPU 32 issues commands to read data stored in the EEPROM 35 as needed. The EEPROM 35 also has an address book storage area 350 (not shown; a first storing section) capable of storing a plurality of address book records. Each address book record includes a set of data entries, including a contact name, telephone number, and e-mail address for identifying a single communication contact. By operating keys on the operating unit 42, the user can input a name, a nickname, telephone numbers, and an e-mail address associated with the name, assign the data to a telephone book record number, and store the inputted data in the address book storage area 350 as a single address book record. In other words, the EEPROM 35 functions to store address book records. Address book records received from an external device (a second storing section), such as records stored in an EEPROM on a separate communication device, can also be stored in the address book storage area 350.

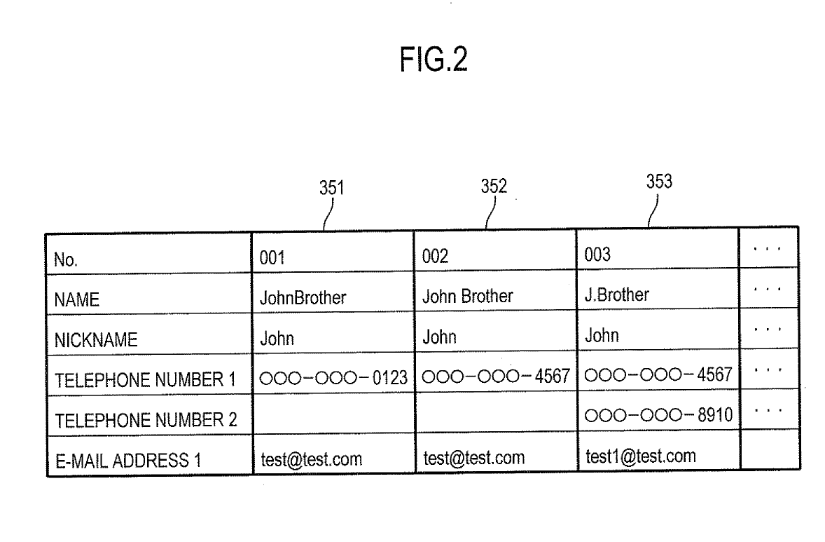

FIG. 2 is an explanatory diagram conceptually illustrating address book records stored in the address book storage area 350 of the MFP 1. In FIG. 2, address book records 351-353 are managed as units based on an assigned record number. In other words, data for a name, nickname, telephone numbers, e-mail address, and the like are associated as a set with a record number. Ordinarily, numerous address book records can be stored in the address book storage area 350.

In the first embodiment, each address book record can be configured of a single name, a single nickname, two telephone numbers, and a single e-mail address associated with a single record number, but the address book record of the present invention is not limited to this configuration. Other data may be recorded in each record, provided the record includes at least a name, and either a telephone number or an e-mail address.

The display unit 41 displays option menus, instructions for performing operations, and the like. Images are displayed on the display unit 41 according to one of the operational programs described above that is executed by the CPU 32 to read display data from the ROM 33. The operating unit 42 includes various operating keys and receives instructions through key operations performed by the user. Specifically, when the user presses operating keys on the operating unit 42, the operating unit 42 transfers data corresponding to the pressed keys to the CPU 32, and the CPU 32 performs processes associated with the key data.

The scanning unit 43 includes an image sensor, an LED light source, and a document conveying motor (none of which are shown in the drawings), for example. The scanning unit 43 functions to scan images from a facsimile original or the like under control of the CPU 32. The printing unit 44 prints images such as text and graphics in monochrome or color on recording paper based on print data. The printing unit 44 uses a thermal system or inkjet system, for example.

The speaker 45 functions to output voice data. The power source detection unit 46 detects when power is supplied from a commercial power source. Specifically, the power source detection unit 46 detects whether power is supplied to the MFP 1 from a commercial power source when the power connector 15 is inserted into a power outlet.

The LAN interface unit 47 is a processor enabling the MFP 1 to implement a communication function as an internet facsimile device. More specifically, the LAN interface unit 47 has an interface circuit designed to connect the CPU 32 and the like to the LAN 17 and performs processes to convert protocols and the like. In addition to the MFP 1, client computers, mail servers, routers, and the like are connected to the LAN interface unit 47.

The LAN interface unit 47 is connected to the internet 18 via a router (not shown). Through this network configuration, the MFP 1 can exchange data with external communication devices connected to the LAN 17 and internet 18. When the MFP 1 is functioning as an internet facsimile device, the LAN interface unit 47 can exchange e-mail with image data attachments with mail servers on the LAN 17. The e-mail is further exchanged between a contact's communication device through multiple mail servers on the LAN 17 and internet 18.

The NCU 48 is a processor implementing a communication function as a G3 facsimile device and a communication function as a telephone device through the connection with the PSTN 20. Specifically, the NCU 48 has a hardware circuit designed to close and open a DC loop with the analog PSTN 20 in order to connect to the PSTN 20 when needed.

### (The Contact Data Management Program Executed on the MFP 1 According to the First Embodiment)

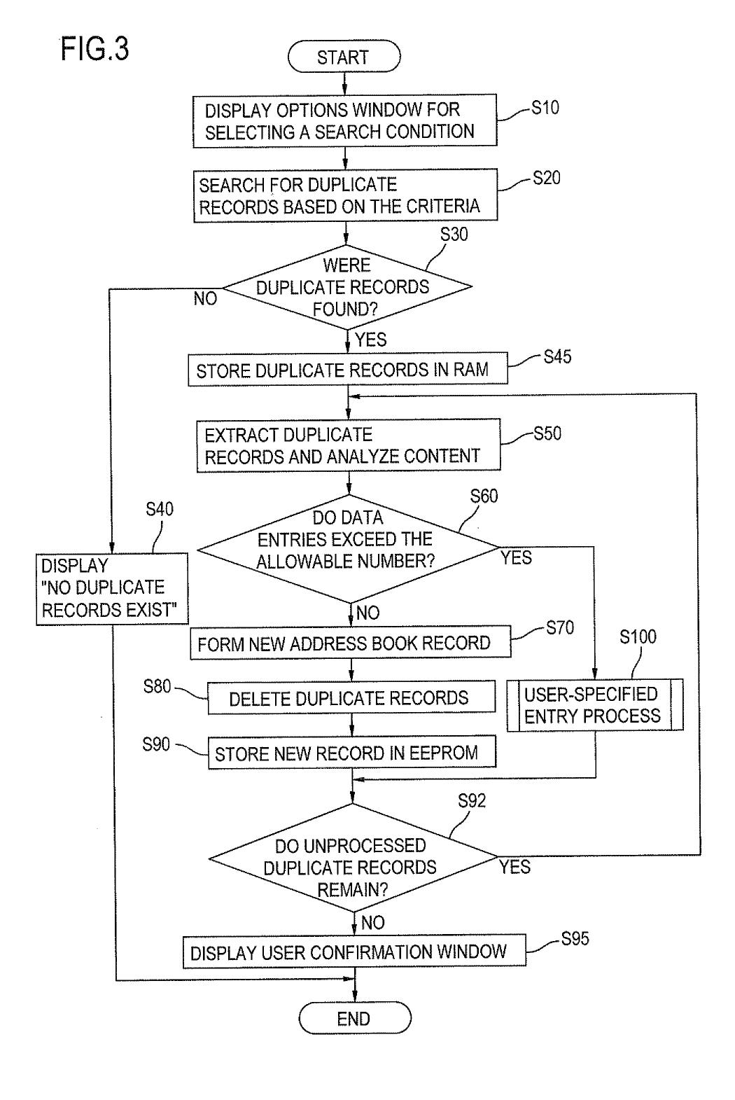

Next, the process of the contact data management program executed by the MFP 1 according to the first embodiment will be described with reference to FIGS. 3-16. FIG. 3 is a flowchart illustrating steps in a process executed by the CPU 32 of the MFP 1 according to the contact data management program. The contact data management program implements a process to determine whether two or more address book records stored in the address book storage area 350 of the EEPROM 35 share the same content for a data type, such as name, nickname, telephone number, and e-mail address, when content is sorted by data type. Hereinafter, records that share the same content for a data type are referred to as “duplicate records.” The process implemented by the contact data management program also combines the sets of data entries for all data types included in duplicate records into a single address book record.

The CPU 32 launches the contact data management program described in FIG. 3 when the user operates keys on the operating unit 42 to choose the selection “Combine duplicate data in the address book” from a menu provided on the MFP 1 and the CPU 32 recognizes that the user has made a selection.

In S10 at the beginning of the process in FIG. 3, the CPU 32 displays an Options window on the display unit 41 enabling the user to specify a search condition for searching for duplicate records. In the Options window, the user is prompted to specify criteria for searching for duplicate records from the plurality of address book records stored in the address book storage area 350.

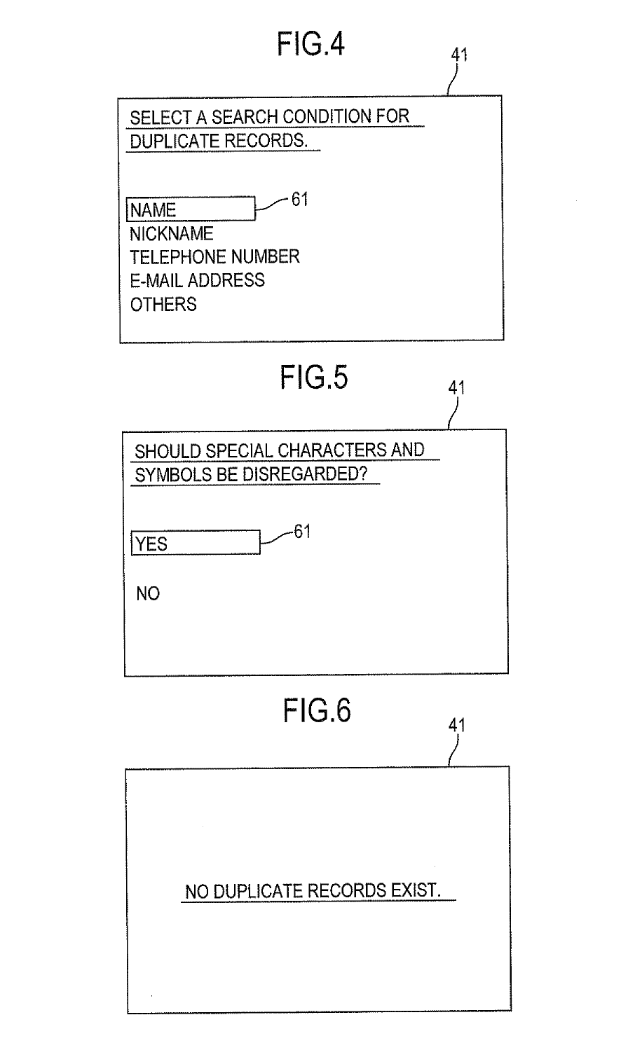

FIGS. 4 and 5 are explanatory diagrams of the Options window. When the window shown in FIG. 4 is first displayed in S10, the user moves a cursor 61 displayed in the window by operating up and down arrow keys (not shown) provided on the operating unit 42 to select a search condition. The options for search conditions include the data types in the address book records, such as name, nickname, telephone number, and e-mail address and narrow the search for common data to the selected data type. In the example of FIG. 4, “Name” has been selected.

By enabling the user to select one of the data types name, nickname, telephone number, and e-mail address included in the records as a basis for finding duplicate records, the MFP 1 of the first embodiment can narrow the search to a specific data type and quickly find address book records possessing common data.

When the user subsequently presses an OK key (not shown) provided on the operating unit 42, the CPU 32 detects that the OK key was pressed and sets the search condition to the data type currently selected by the user. Next, the CPU 32 displays the window shown in FIG. 5 on the display unit 41. This window includes a message prompting the user to indicate whether to disregard special characters and symbols, such as spaces, included in the data type selected in FIG. 4.

The user moves the cursor 61 using the up and down arrow keys provided on the operating unit 42 to select either “Yes” or “No” in the window and subsequently presses the OK key. Upon detecting that the OK key was pressed, the CPU 32 performs the process corresponding to the “Yes” or “No” selection indicated by the user. In the example of FIG. 5, the user has selected “Yes.” In this case, although the name data “John Brother” recorded in the address book record 352 includes a space character, the name data is treated as “JohnBrother,” disregarding the space.

Hence, in the first embodiment, special characters and symbols such as the space are disregarded from the selected data type when comparing records. Therefore, the CPU 32 can determine whether the data entries corresponding to a data type in two records match, even if the data entries include special characters and symbols, based on other characters (i.e., characters other than special characters and symbols) and the order of these other characters.

After the user specifies a search condition for searching for duplicate data, in S20 the CPU 32 reads the address book records stored in the address book storage area 350 (see FIG. 2) and searches for duplicate data based on the search condition set in S10. More specifically, the CPU 32 reads all of the address book records stored in the address book storage area 350, temporarily develops the data in the RAM 34, extracts one record from the developed data, and determines whether the data content corresponding to the data type specified as the search condition matches the data content in the other address book records developed in the RAM 34. For example, the CPU 32 first extracts the address book record 351 in FIG. 2, determines that the data content for the name is “JohnBrother,” and searches for other address book records having the same name data. In this way, the CPU 32 extracts one of the address book records stored in the address book storage area 350 and sequentially searches for common data in the other address book records based on the specified search condition.

In S30 the CPU 32 determines whether any duplicate records were found when searching all address book records stored in the address book storage area 350. If the CPU 32 determines that no duplicate records exist (S30: NO), in S40 the CPU 32 displays a message on the display unit 41, such as that shown in FIG. 6, indicating that there are no duplicate records. FIG. 6 is one example of a message displayed on the display unit 41 to indicate that no duplicate records exist.

However, in the example of FIG. 2, the address book records 351 and 352 stored in the address book storage area 350 include the name data “JohnBrother” and “John Brother,” respectively. Hence, based on the search condition set in S10 (data type: Name, disregard special characters: Yes), the CPU 32 determines in S30 that duplicate records exist (S30: YES), and in 345 stores the RAM storage location for each record containing the common data in the RAM 34 as a set of duplicate records.

In S50 the CPU 32 reads the storage locations of the duplicate records stored in S45, extracts the set of duplicate records from the RAM 34, and analyzes each of the data types included in the duplicate records. In this analysis, the CPU 32 counts common data entries for each data type as one entry and counts each unique data entry for each data type as one entry.

Since name data was selected as the search condition in this example, the address book records 351 and 352 were found to have common name data when the address book records were searched. Hence, when analyzing the content of each data type in the address book records 351 and 352 and counting the set of common data entries as a single entry and each unique data entry as a separate entry, the CPU 32 counts one entry for the common name data, two entries for the different telephone number data, and one entry for the shared e-mail address data.

In S60 the CPU 32 determines whether the number of data entries counted in S50 for each data type exceeds the number of entries that can be recorded in a single address book record. As described earlier, the MFP 1 can record one name, two telephone numbers, and one e-mail address in one address book record. Therefore, the CPU 32 determines in S60 that the number of data entries counted in S50 for each data type does not exceed the number of allowable data entries for a single address book record (S60: NO). A case in which the number of calculated data entries for a data type exceeds the allowable number of data entries for a single address book record (S60: YES) will be described later.

When the CPU 32 reaches a NO determination in S60, in S70 the CPU 32 combines the data entries included in duplicate records in a set to form a single address book record in the RAM 34. In this example, the CPU 32 forms a single address book record with one name, two telephone numbers, and one e-mail address acquired from the address book records 351 and 352. In S80 the CPU 32 deletes the duplicate records from the address book storage area 350, i.e., the address book records 351 and 352 in this example.

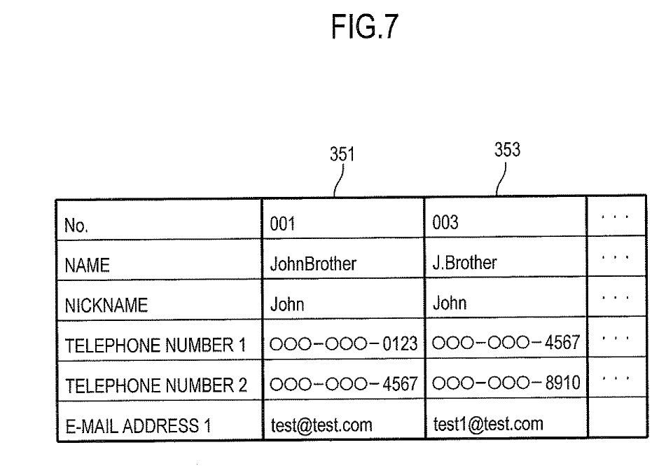

In S90 the CPU 32 stores the new address book record formed in S70 in the address book storage area 350 of the EEPROM 35. FIG. 7 shows the address book record stored in the address book storage area 350 after performing the process in S90 for this example. As shown in FIG. 7, the single address book record formed from the address book records 351 and 352 is stored as a new address book record 351 in association with the record no. 001, while the address book record 352 has been deleted. In the first embodiment, it is also possible to store the new address book record 351 in the address book storage area 350 and assign a record number that has not been assigned to another address book record, rather than storing the new address book record 351 in place of the deleted address book record 351.

In the first embodiment described above, data entries included in address book records having common data entries (duplicate records) are combined into a single address book record and stored in the address book storage area 350. Hence, the MFP 1 according to the first embodiment can effectively use the address book storage area 350 without needlessly increasing the number of address book records stored in the address book storage area 350. This method is particularly effective for multifunction peripherals and other communication devices having an address book storage area capable of storing only a limited number of address book records.

Further, by avoiding a needless increase in the number of address book records stored in the address book storage area 350, the address book records are more easily managed. For example, when the user wishes to search the address book records in the address book storage area 350 for a desired record, the MFP 1 can more quickly search for and retrieve the desired address book record when there are fewer records to search.

Further, the MFP 1 according to the first embodiment prevents common data entries from being included in a single address book record when forming a single address book record from the sets of data entries included in duplicate records. Hence, eliminating duplicate data entries can avoid unnecessary data from being stored in a record, thereby more effectively utilizing the address book storage area 350.

Further, in the first embodiment, the CPU 32 creates a single address book record by combining the common data entries with the unique data entries of duplicate records as a set, stores the new address book record in the address book storage area 350, and deletes the duplicate records from the address book storage area 350. Hence, the CPU 32 can include data entries that are not shared between the duplicate records together with the common entries in a single address book record. Since the address book records can be written to and deleted from the address book storage area 350 as a unit, processing is simplified.

Next, in S92 the CPU 32 determines whether there exist any duplicate records for which the process to form a single address book record has not been executed. If there remain any unprocessed duplicate records (S92: YES), the CPU 32 returns to S50, extracts a set of duplicate records stored in the RAM 34, and analyzes the duplicate records as described above. In this way, the CPU 32 repeatedly performs the process to reorganize duplicate records into a single address book record. However, when there are no more unprocessed duplicate records (S92: NO), in S95 the CPU 32 displays a window on the display unit 41 with a message prompting the user to confirm the content of the address book records formed by combining duplicate records, and subsequently ends the process. When ending the process, the CPU 32 also deletes the developed address book records from the RAM 34.

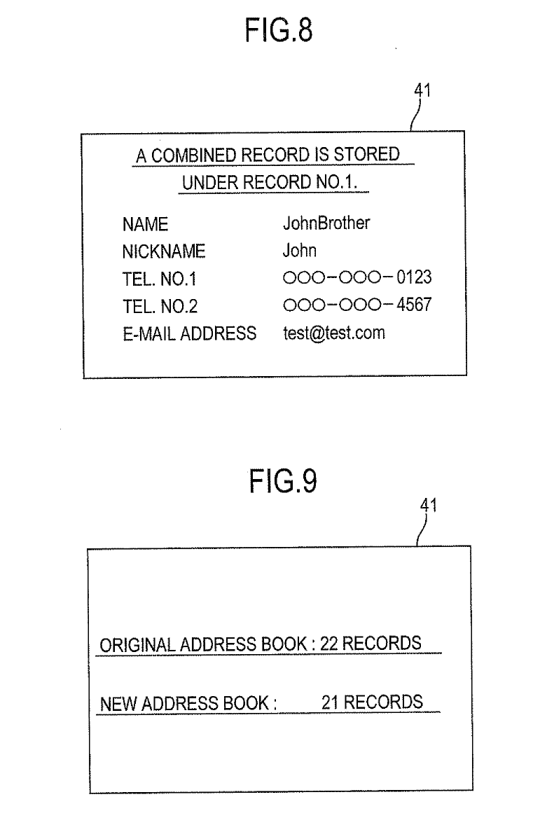

FIG. 8 shows a sample user confirmation window displayed on the display unit 41 in S95. FIG. 9 shows another example of the user confirmation window. After forming a single address book record from the duplicate records, the CPU 32 displays the content of the new address book record, as shown in FIG. 8, or displays the number of address book records in the address book storage area 350 before and after the records were reorganized, as shown in FIG. 9, enabling the user to confirm immediately the results of combining duplicate records in the above process.

### (User-Specified Entry Process)

When the CPU 32 determines in S60 of FIG. 3 that the number of entries calculated in S50 for a data type exceeds the number of allowable data entries for a single address book record (S60: YES), in S100 the CPU 32 performs a user-specified entry process. If the user has selected the nickname data type as the search condition in S10 when a NO determination is made in S60, for example, in S20 the CPU 32 searches the address book records for records having the same data entry for the nickname data type.

As a result, in S30 the CPU 32 determines that the address book records 351-353 (see FIG. 2) are all duplicate data because they all include the nickname data “John.” In S50 the CPU 32 analyzes the data entries corresponding to each data type in the address book records 351-353 as described above, and calculates the number of entries by counting common data entries as one entry. Consequently, the CPU 32 determines that there are two names, one nickname, three telephone numbers, and two e-mail addresses.

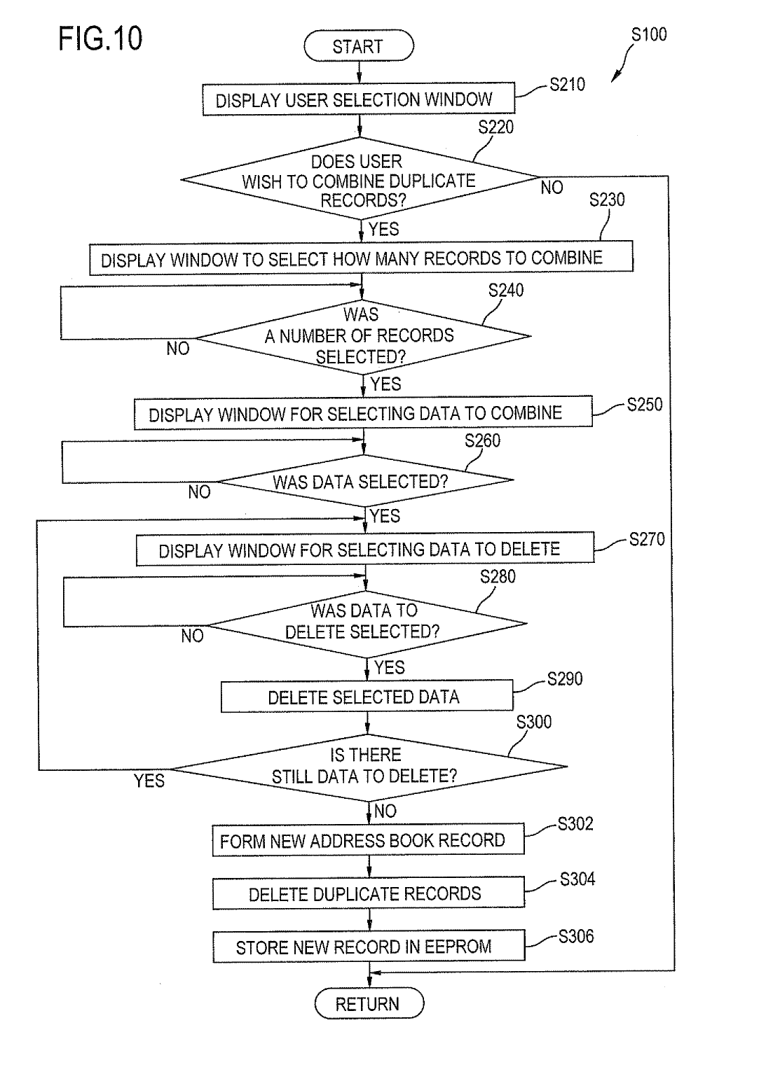

In the first embodiment, one name, one nickname, two telephone numbers, and one e-mail address can be recorded in a single address book record. In this example, the CPU 32 determines that the number of entries for the name data, telephone number data, and e-mail address data all exceed the number of allowable entries for a single address book record (S60: YES) and advances to the user-specified entry process of S100. FIG. 10 is a flowchart illustrating steps in the user-specified entry process. This user-specified entry process is executed when the number of data entries in extracted duplicate records for any data type is too large to fit in a single address book record.

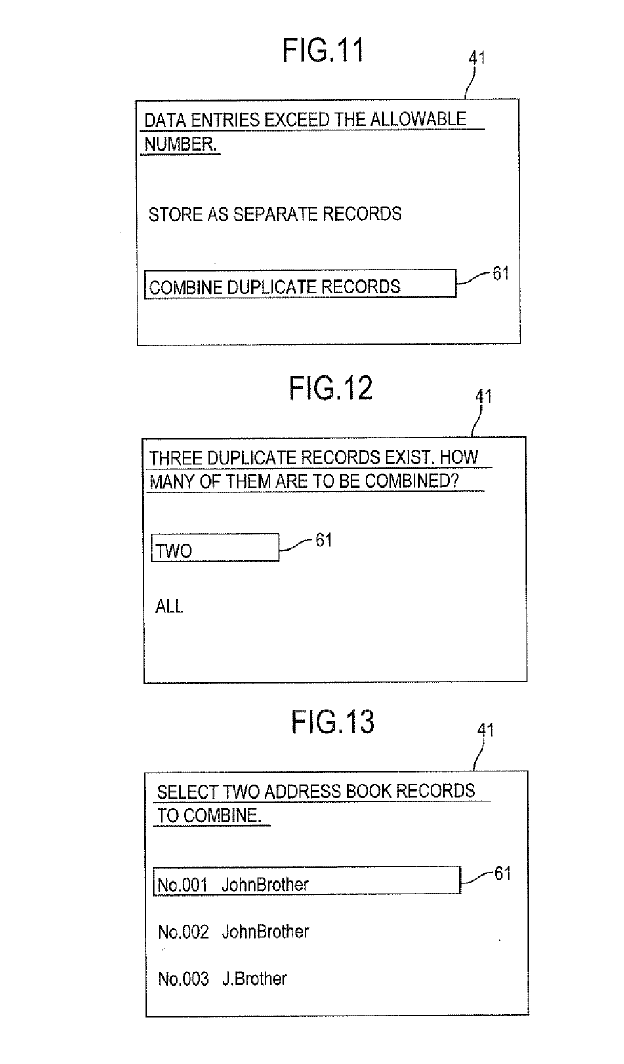

In S210 of FIG. 10, the CPU 32 first displays a user selection window on the display unit 41. FIG. 11 shows an example of the user selection window. The user selection window in the example of FIG. 11 offers a selection to record duplicate address book records as separate records and a selection to combine the duplicate address book records. The user moves the cursor 61 by operating the up and down arrow keys provided on the operating unit 42 to make a selection. In FIG. 11 the user has selected “Combine duplicate records.”

When the user presses the OK key provided on the operating unit 42, the CPU 32 detects that the OK key was pressed and in S220 determines whether the “Combine duplicate records” is selected in the window of FIG. 11 at this time. If the CPU 32 determines that the “Combine duplicate records” was not selected in the window of FIG. 11 (S220: NO), the CPU 32 ends the user-specified entry process of S100 and returns to FIG. 3.

However, if the CPU 32 determines that “Combine duplicate records” is selected (S220: YES), in S230 the CPU 32 displays a selection window on the display unit 41 prompting the user to select how to combine the duplicate records. FIG. 12 is an explanatory diagram showing a sample selection window for selecting the number of address book records to combine. Since the three address book records 351-353 are determined to all have duplicate data in this example, the selection window displayed in FIG. 12 allows the user to choose whether to combine two of the three address book records or all three of the address book records.

By operating the up and down arrow keys and pressing the OK key provided on the operating unit 42, the user can select the number of records to combine and store in the address book storage area 350 as a single address book record. In the example of FIG. 12, the user has chosen to combine two address book records. In the selection window shown in FIG. 12, the user may select the number of address book records to combine using the cursor 61 or may press a number key (not shown) on the operating unit 42 to input the number of address book records to combine.

In S240 the CPU 32 determines whether the user has selected a number of records to combine. If a selection has not yet been made (S240: NO), the CPU 32 repeats the determination in S240 until a selection has been made. When the user has selected the number of address book records to combine, i.e., has moved the cursor 61 with the up and down arrow keys to a desired selection and has pressed the OK button, for example (S240: YES), in S250 the CPU 32 displays a selection window on the display unit 41 prompting the user to select the address book records to combine. FIG. 13 is an explanatory diagram showing a sample selection window for selecting which address book records to combine.

Since the CPU 32 determined in S20 and S30 of FIG. 3 described above that the three address book records 351-353 have common data, three selection identifying each of the address book records 351-353 are displayed in the selection window in FIG. 13, along with a message prompting the user to select two of the three records. Although only the record number and the name are displayed in FIG. 13, the method of displaying record data is not limited to this configuration, provided that the user can distinguish among the address book records 351-353. For example, the telephone numbers and e-mail addresses may also be displayed. The user selects the address book records to combine by repeatedly moving the up and down arrow keys and pressing the OK key on the operating unit 42. In this example, it will be assumed that the user selected the address book records 351 and 353 to combine.

In S260 the CPU 32 determines whether the address book records to combine have been selected in the selection window of FIG. 13. This determination is made based on whether the number of address book records selected by the user in S240 has been specified in the selection window of FIG. 13 when the CPU 32 detects that the OK key was pressed. If the CPU 32 determines that the specified number of address book records to be combined has not been selected (S260: NO), the CPU 32 repeats the determination in S260 until the number of address book records to be combined has been selected. When the CPU 32 determines that all address book records to be combined have been selected (S260: YES), in S270 the CPU 32 displays a selection window on the display unit 41 prompting the user to indicate a data entry (or data entries) to delete from the selected records for a data type having more entries than the allowable number that can be stored in a single record.

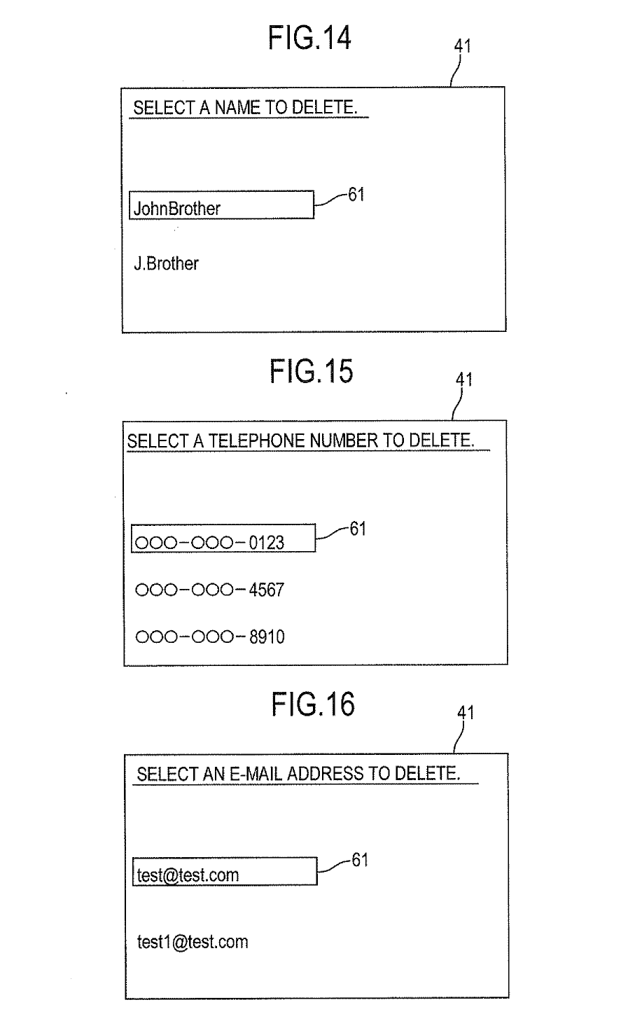

Since the user has chosen to combine the address book records 351 and 353 into a single address book record in this example, data entries in these records for each of the name, telephone number, and e-mail address data types exceeds the number of allowable entries for a single address book record. Hence, the CPU 32 first reads the name data for the address book records 351 and 353 and displays a selection window on the display unit 41 including the name data, prompting the user to delete a name. FIG. 14 is an explanatory diagram showing a sample selection window prompting the user to select a name to delete. FIG. 14 displays “JohnBrother” as the name in the address book record 351 and “J.Brother” as the name in the address book record 353. Since only one name can be recorded in a single address book record, the user must select one name to delete by operating the up and down arrow keys and pressing the OK button on the operating unit 42. In the example of FIG. 14, “JohnBrother” has been selected as the name to be deleted.

In S280 the CPU 32 determines whether a name to be deleted has been selected based on content of the display screen when the OK key was pressed. If the CPU 32 determines that a name to be deleted has not been selected (S280: NO), the CPU 32 repeats the determination in S280 until a name has been selected. When the CPU 32 determines that a name to be deleted has been selected (S280: YES), in S290 the CPU 32 sets the selected name, i.e., “JohnBrother” in this example, as the name to be deleted.

In S300 the CPU 32 determines whether there remain data entries that must be deleted in order to combine the address book records. Since entries for the telephone number and e-mail address must be deleted in this example, the CPU 32 determines that there are still entries to be deleted (S300: YES). Consequently, the CPU 32 returns to S270, reads the telephone number data from the address book records 351 and 353, and displays a selection window on the display unit 41 prompting the user to select a telephone number to delete.

FIG. 15 is an explanatory diagram showing a selection window for selecting a telephone number to delete. The selection window in FIG. 15 displays the telephone number “000-000-0123” from the address book record 351 and the telephone numbers “000-000-4567” and “000-000-8910” from the address book record 353. Since only two telephone numbers can be recorded in a single address book record, the user must select a telephone number to delete by operating the up and down arrow keys and pressing the OK key provided on the operating unit 42. In the example of FIG. 15, the user has selected “000-000-0123” as the telephone number to delete. When it is necessary to delete two or more entries, the number of entries to delete is specified in this selection window.

As described earlier for S280, the CPU 32 determines whether a telephone number to be deleted has been selected. If a telephone number to be deleted has been selected (S280: YES), in S290 the CPU 32 sets the selected telephone number, i.e., “000-000-0123” in this example, as the telephone number to be deleted.

Once again in S300 the CPU 32 determines whether there remain data entries that must be deleted in order to combine the address book records. Since it is necessary to delete one e-mail address in this example, the CPU 32 determines that there are still entries to be deleted (S300: YES), and returns to S270. In S270 the CPU 32 reads the e-mail address data from the address book records 351 and 353, and displays a selection window on the display unit 41 prompting the user to select an e-mail address to delete.

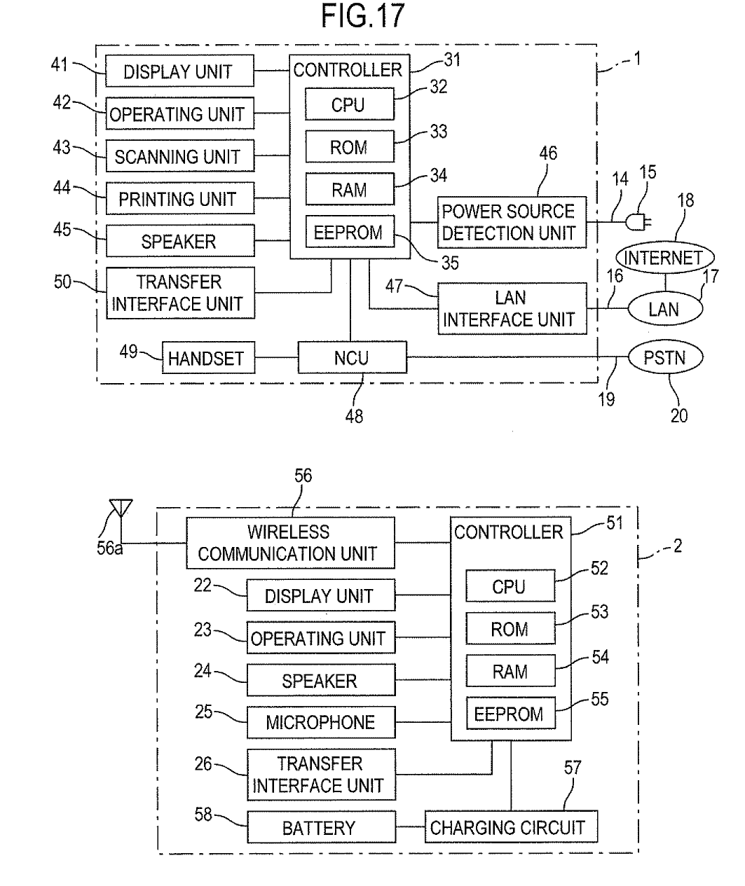

FIG. 16 is an explanatory diagram showing a sample selection window for selecting an e-mail address to delete. Based on the display in FIG. 16, the user has selected “test@test.com” as the e-mail address to delete. Hence, the CPU 32 sets “test@test.com” as the e-mail address to delete.

Upon returning to S300, the CPU 32 determines there are no more data entries that must be deleted (S300: NO). Accordingly, in S302 the CPU 32 combines all remaining data entries from the address book records 351 and 353 that were not deleted above into a single address book record. In this example, the CPU 32 combines the name “J.Brother,” the nickname “John,” the telephone numbers “000-000-4567” and “000-000-8910,” and the e-mail address “test1@test.com” as a set and records this set of data in the RAM 34 as a single address book record.

In S304 the CPU 32 deletes the duplicate records. Specifically, the CPU 32 deletes the address book records 351 and 353 from the address book storage area 350 in this example. In S306 the CPU 32 stores the new address book record created in S302 in the address book storage area 350 of the EEPROM 35 as a new address book record 351. At this time, the CPU 32 stores the new address book record 351 formed by combining the address book records 351 and 353 in place of the old address book record 351 under record no. 001. Subsequently, the CPU 32 ends the user-specified entry process of S100 and returns to FIG. 3.

After completing the user-specified entry process of S100, in S95 of FIG. 3 the CPU 32 displays a window on the display unit 41 with a message prompting the user to confirm the content of the address book records formed by combining duplicate records, and subsequently ends the process. As described above, after duplicate data are combined into a single address book record, the CPU 32 displays the content of the new address book record (see FIG. 8), or displays the number of address book records in the address book storage area 350 before and after the records were organized (see FIG. 9) on the display unit 41. When ending the process in FIG. 3, the CPU 32 also deletes the developed address book records from the RAM 34.

In the first embodiment described above, the MFP 1 combines data entries in address book records determined to possess common data entries to form a single address book record. When the MFP 1 determines that the number of data entries for any data type exceeds the allowable number for a single address book record, the MFP 1 deletes data entries specified by the user from the combined address book record to adjust the number of data entries to a number that can be included in the single address book record. Subsequently, the MFP 1 stores this new address book record in the address book storage area 350. Hence, the MFP 1 can delete unnecessary data entries from address book records being combined into a single record and can store the resulting record in the address book storage area 350.

Further, in the first embodiment described above, the MFP 1 deletes data entries included in an address book record formed by combining a plurality of records based on instructions inputted by the user through the operating unit 42. Hence, the MFP 1 can form a single address book record from a plurality of records by deleting data entries according to user instructions and retain data entries that the user wishes to keep, and can store the resulting single address book record in the address book storage area 350.

While the present invention has been described in detail with reference to a first embodiment thereof, the invention is not limited to this embodiment. For example, in the first embodiment described above, the CPU 32 searches for duplicate records among the records stored in the address book storage area 350 of the EEPROM 35, and combines duplicate records into a single address book record. However, if the MFP 1 is configured to receive address book records from a storage device, mobile telephone, or other device capable of being detachably connected to the MFP 1, the CPU 32 may search for duplicate records among the records received from the storage device or mobile telephone and the records stored in the address book storage area 350 of the MFP 1 and may combine any records with common data into a single address book record. This configuration will be described in detail as a second embodiment.

### (Structure of a Communication Device According to a Second Embodiment)

Next, a second preferred embodiment of the present invention will be described while referring to the accompanying drawings. FIG. 17 is a block diagram showing the internal structure of the MFP 1 to which the present invention is applied, and a mobile telephone 2. The mobile telephone 2 has an EEPROM 55 serving as an example of an external storage device. In the MFP 1 shown in FIG. 17, like parts and components to those in the MFP 1 of FIG. 1 are designated with the same reference numerals. The MFP 1 according to the second embodiment has a structure identical to the MFP 1 in the first embodiment, but is additionally provided with a transfer interface unit 50 connected to the controller 31.

The transfer interface unit 50 includes an RS232C or other interface for transmitting address book records stored in the address book storage area 350 to the mobile telephone 2 along a transmission path formed of a cable (wired) and for receiving address book records from the mobile telephone 2 via the transmission path. However, the present invention is not limited to a transmission path configured of a cable. For example, the transfer interface unit 50 may include a wireless transceiver and a transceiver antenna and may exchange address book records with radio waves transmitted along a path configured of free space. Further, the transfer interface unit 50 may include an optical transceiver and a light emitter/receiver and may exchange address book records with optical signals transmitted along a path configured of free space.

Thus, with the transfer interface unit 50 described above, the MFP 1 of the second embodiment can receive address book records from the mobile telephone 2 and can store records received from the mobile telephone 2 in the address book storage area 350 of the EEPROM 35.

Next, the structure of the mobile telephone 2 will be described with reference to FIG. 17. The mobile telephone 2 is an example used in the second embodiment, but may be any portable data terminal having a communication function and capable of processing data. As shown in FIG. 17, the mobile telephone 2 is internally provided with a controller 51. The controller 51 further includes a CPU 52, a ROM 53, a RAM 54, and the EEPROM 55. The CPU 52, ROM 53, RAM 54, and EEPROM 55 are interconnected via a bus (not shown). The controller 51 is also connected to a wireless communication unit 56, a display unit 22, an operating unit 23, a speaker 24, a microphone 25, a transfer interface unit 26, a battery 58, and a charging circuit 57.

The CPU 52 controls the overall operations of the mobile telephone 2. Further, when a transmission request for address book records is received from the MFP 1, the CPU 52 reads the address book records corresponding to the transmission request from the EEPROM 55 and transmits these records to the MFP 1 via the transfer interface unit 26. This process will be described later in greater detail.

The ROM 53 stores various operational programs executed by the CPU 52, constants used in the various processes, display data to be displayed on the display unit 22, data for the telephone function, and the like. The RAM 54 provides among other things a work area for the CPU 52. The EEPROM 55 stores image data, text data, address book records, and other data. The CPU 52 issues commands to read data stored in the EEPROM 55 as needed. As with the EEPROM 35 in the MFP 1, the EEPROM 55 is also provided with an address book storage area 550 (not shown) for storing address book records including telephone numbers and the like for contacts. As described with the MFP 1 of the first embodiment, the user operates keys on the operating unit 23 to input contact data for address book records, and the address book records are sequentially stored in the EEPROM 55. Address book records received from the MFP 1 or the like via the transfer interface unit 26 described later can also be stored in the address book storage area 550 of the EEPROM 55.

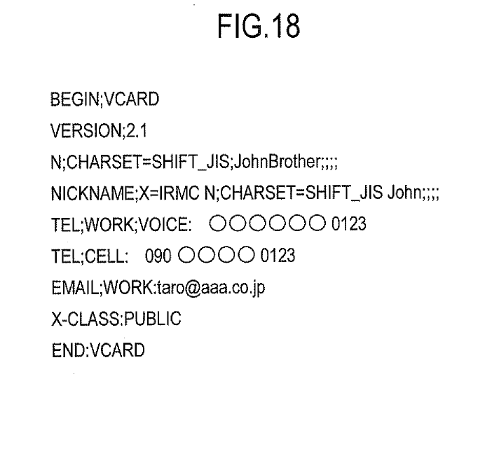

FIG. 18 shows a sample content of an address book record 551 stored in the address book storage area 550 of the EEPROM 55 in the vCard file format. The address book record 551 is managed as a unit associated with a record number and is configured of a set of data entries identifying a single communication contact. The set of data entries include name data, nickname data, telephone number data, and e-mail address data associated with the record number.

As shown in FIG. 18, the address book record 551 begins with the line “BEGIN:VCARD,” follows with specific data for the vCard, and ends with the line “END:VCARD.” When there are a plurality of address book records, stored in the address book storage area 550 is a plurality of data sets beginning from the line “BEGIN:VCARD” and ending with the line “END:VCARD.”

In FIG. 18, data entries included in the address book record 551 is written in a prescribed format between the lines “BEGIN:VCARD” and “END:VCARD.” Data types for the data entries are listed as “N” (name), “NICKNAME” (nickname), “TEL” (telephone number), “EMAIL” (e-mail address), and the like. The data following each data type are specific data entries (name data, nickname data, telephone number, e-mail address, etc.) inputted or specified by the user for the respective data type.

Further, each data type can be specified in detail by inserting a “;” after the data type, followed with attributes. For example, “TEL;WORK;VOICE” shown in FIG. 18 represents a work telephone number, while “TEL;CELL” indicates a mobile telephone number. These attributes may also specify a telephone number for home, school, and the like. Similar attributes can be provided for other data types, such as “EMAIL.”

The display unit 22 displays option menus, instructions for performing operations, and the like. Images are displayed on the display unit 22 according to one of the operational programs described above that is executed by the CPU 52 to read displayed data from the ROM 53. The operating unit 23 includes various operating keys. When the user presses operating keys on the operating unit 23, the operating unit 23 transfers data corresponding to the pressed keys to the CPU 52. Upon receiving data for pressed keys, the CPU 52 performs processes associated with the key data. The wireless communication unit 56 includes an antenna 56a and exchanges audio signals and other data with the MFP 1 or another mobile telephone using a control channel and a talk channel. The speaker 24 and microphone 25 can implement a telephone call with another mobile telephone or a landline telephone.

The transfer interface unit 26 includes an RS232C or other interface by which the transfer interface unit 26 can transmit address book records to the MFP 1 via a transmission path configured of a cable, and can receive address book records from the MFP 1 via the transmission path. As described above, the present invention is not limited to a transmission channel configured of a cable, but may be formed of radio waves or optical signals in free space.

(The Contact Data Management Program Executed on the MFP 1 According to the Second Embodiment)

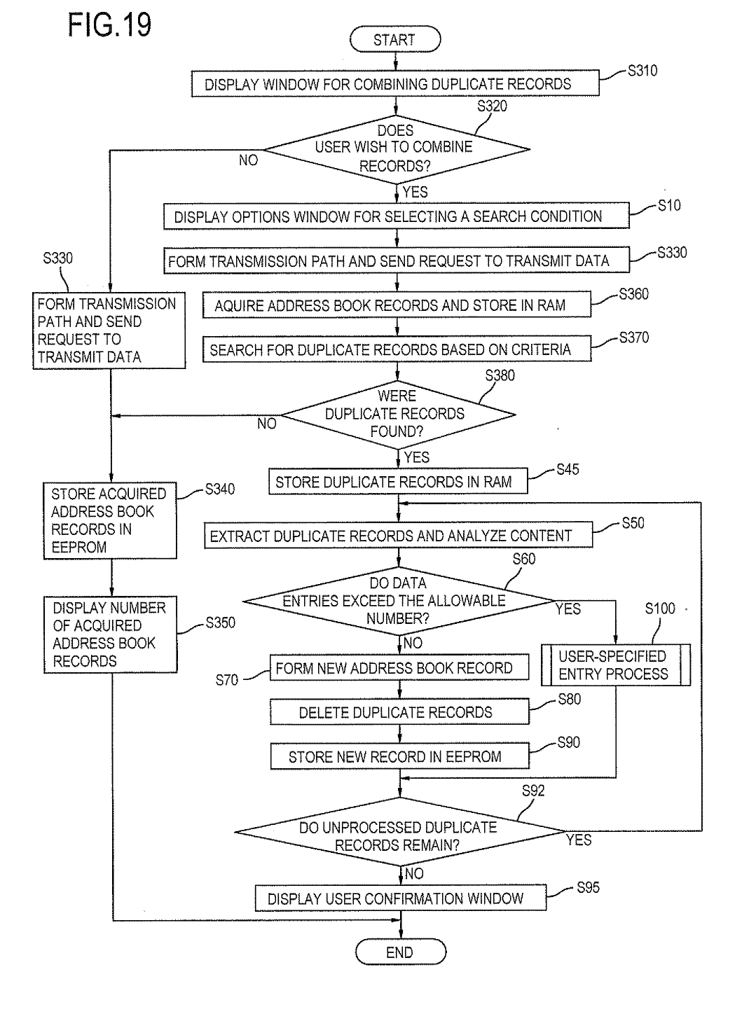

Next, the process of the contact data management program executed by the MFP 1 according to the second embodiment will be described with reference to FIGS. 19-21. FIG. 19 is a flowchart illustrating steps in a process executed by the CPU 32 of the MFP 1 in accordance with the contact data management program. In FIG. 19, steps identical to those in the process of FIG. 3 according to the first embodiment are designated with the same step numbers.

The CPU 32 executes the contact data management program shown in FIG. 19 when the user operates keys on the operating unit 42 to choose the selection “Receive address book records” from a menu displayed on the display unit 41 of the MFP 1 and the CPU 32 recognizes that the user has specified the “Receive address book records” selection.

In S310 at the beginning of the process in FIG. 19, the CPU 32 displays an Options window on the display unit 41 prompting the user to indicate whether to combine duplicate records. Here, the definition of duplicate records is identical to that described in the first embodiment.

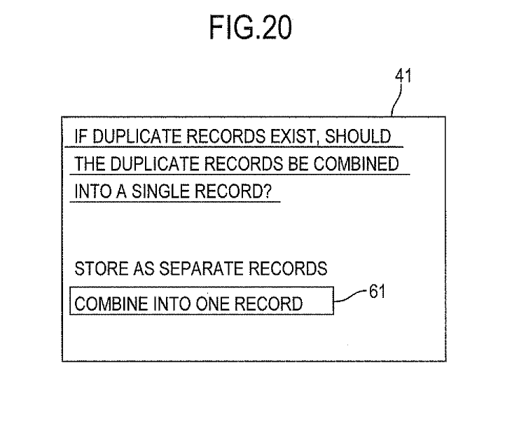

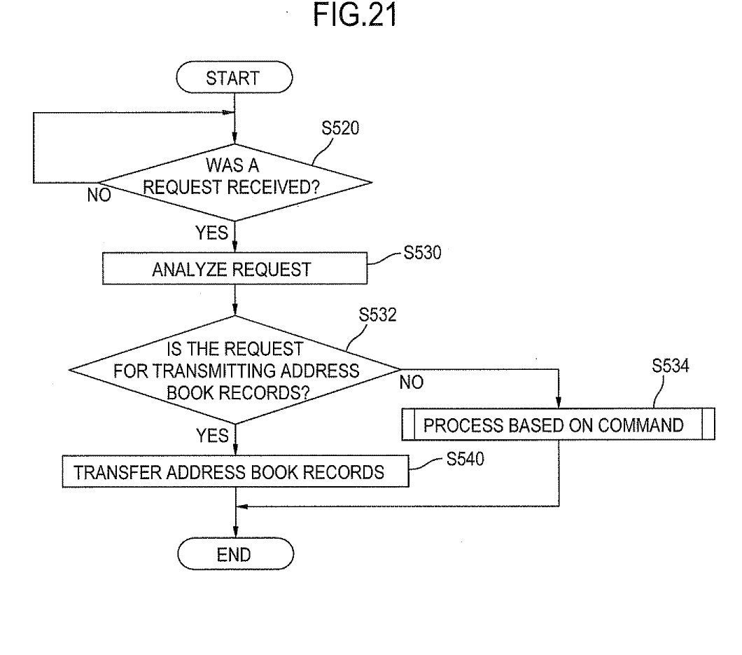

FIG. 20 is an explanatory diagram of the Options window prompting the user to select whether to combine duplicate records. The Options window in FIG. 20 enables the user to make a choice when address book records received from an external source have common data with the address book records stored in the address book storage area 350 of the MFP 1. Here, the user can select whether to record the received duplicate records as separate address book records or to combine each set of duplicate records into a single address book record.

The user moves the cursor 61 by operating the up and down arrow keys provided on the operating unit 42 to make a selection. In the example of FIG. 20, the user has selected “Combine into one record.” The user subsequently accepts this selection by pressing the OK key provided on the operating unit 42. When the CPU 32 detects that the OK key was pressed, in S320 the CPU 32 determines whether the user selected the “Combine into one record” option based on the cursor position in the Options window when the OK key was pressed.

If the CPU 32 determines that the “Combine into one record” option was not selected (S320: NO), in S330 the CPU 32 activates the transfer interface unit 50 to establish a transmission path to the transfer interface unit 26 of the mobile telephone 2. A case in which the user selects “Combine into one record” (S320: YES) will be described later. Next, the operations of the MFP 1 to receive address book records from the address book storage area 550 of the mobile telephone 2 will be described with reference to FIGS. 19 and 21. FIG. 21 is a flowchart illustrating steps in a process performed on the mobile telephone 2 for transmitting address book records to the MFP 1.

The CPU 52 of the mobile telephone 2 executes the process shown in FIG. 21 when a transmission path has been formed between the transfer interface unit 50 of the MFP 1 and the transfer interface unit 26 of the mobile telephone 2. In S520 of FIG. 21 the CPU 52 determines whether a request has been received from the MFP 1. In the preferred embodiment, a request is a command requesting the mobile telephone 2 to transfer image data or other data stored in the mobile telephone 2 to the MFP 1 and includes such requests as a transmission request for address book records. If the CPU 52 determines that a request has not been received via the transfer interface unit 26 (S520: NO), the CPU 52 repeats the determination in S520 until the request has been received. If a request is not received from the MFP 1 within a prescribed time, the CPU 52 may disable the transmission path and end the process in FIG. 21.

In the meantime, in S330 of FIG. 19 the CPU 32 of the MFP 1 transmits a transmission request for address book records stored in the address book storage area 550 of the mobile telephone 2 to the mobile telephone 2 via the transfer interface unit 50. Here, the transmission request for address book records may be a command requesting the mobile telephone 2 to transmit all address book records stored in the mobile telephone 2 or may be a command requesting the mobile telephone 2 to transmit only a prescribed address book record. The CPU 32 may also display a selection window on the display unit 41 prompting the user to select the type of the command, thereby selecting the method of transferring the address book records.

When the CPU 52 of the mobile telephone 2 determines in S520 that a request has been received from the MFP 1 via the transfer interface unit 26 (S520: YES), in S530 the CPU 52 analyzes the request. Specifically, the CPU 52 identifies the type of request received from the MFP 1 to determine whether the request is a transmission request to transmit address book records. In S532 the CPU 52 determines whether the request is a transmission request for address book records. If the request received from the MFP 1 is not a transmission request for address book records (S532: NO), in S534 the CPU 52 performs a process associated with the request identified in S530 and subsequently ends the process.

However, if the CPU 52 determines that the request received from the MFP 1 is a transmission request for address book records (S532: YES), in S540 the CPU 52 reads the address book records from the address book storage area 550 of the EEPROM 55 and transmits these records to the MFP 1 via the transfer interface unit 26.

In S340 of FIG. 19, the CPU 32 of the MFP 1 receives the address book records transferred from the mobile telephone 2 via the transfer interface unit 50 in S540 of FIG. 21 and stores the records in the address book storage area 350 of the EEPROM 35. After the MFP 1 receives all of the requested address book records, the CPU 32 and the CPU 52 disable the transmission path between the transfer interface unit 50 and transfer interface unit 26 and end the process to transfer and receive address book records. Accordingly, if the user did not choose in S320 to combine duplicate records into a single address book record, the CPU 32 simply converts the address book records received from the mobile telephone 2 to the address book record format used on the MFP 1 and stores the records in the address book storage area 350.

In S350 the CPU 32 displays a confirmation window on the display unit 41 prompting the user to confirm that the requested address book records were received. For example, the CPU 32 displays the number of address book records received from the mobile telephone 2 or the like (S350) After displaying the confirmation window, the CPU 32 quits the contact data management program.

However, if the CPU 32 determines in S320 that the user selected “Combine into one record” (S320: YES), in S10 the CPU 32 displays an Options window on the display unit 41 enabling the user to specify a search condition for searching for duplicate records. This Options window is identical to that described in the first embodiment, and a description will not be repeated here. In S330 the CPU 32 transfers a transmission request to the mobile telephone 2 via the transfer interface unit 50 requesting that the mobile telephone 2 transmit address book records stored in the address book storage area 550. Since the details of the process in S330 and the details of the process executed by the mobile telephone 2 to receive the transmission request for address book records has been described above, this description will not be repeated.

In S360 the CPU 32 temporarily saves the address book records received from the mobile telephone 2 via the transfer interface unit 50 in the RAM 34. After the MFP 1 has received all requested address book records, the CPU 32 of the MFP 1 and the CPU 52 of the mobile telephone 2 disable the transmission path between the transfer interface unit 50 and transfer interface unit 26 and end the process to transfer and receive address book records.

In S370 the CPU 32 searches the address book records received from the mobile telephone 2 that are stored in the RAM 34 and the address book records stored in the address book storage area 350 of the MFP 1 for duplicate records based on the search condition set for duplicate records in S10. Specifically, the CPU 32 reads the address book records stored in the address book storage area 350 of the EEPROM 35 and develops the data in the RAM 34. Next, the CPU 32 searches the address book records read from the address book storage area 350 and developed in the RAM 34 and the address book records received from the mobile telephone 2 and stored in the RAM 34 for duplicate records based on the criteria set in S10. The process in S370 of the second embodiment is identical to S20 described in the first embodiment in terms of the search method, differing only in that the volume of data being searched is increased by the number of address book records received from the mobile telephone 2.

In S380 the CPU 32 determines whether any duplicate records were found. If duplicate records were found (S380: YES), the CPU 32 performs the process in S50-S100 and S210-S306 described in the first embodiment to combine duplicate records into a single address book record and to store the address book record in the address book storage area 350. However, if the CPU 32 finds no duplicate records (S380: NO), in S340 the CPU 32 stores the address book records received from the mobile telephone 2 and stored in the RAM 34 in the address book storage area 350 of the EEPROM 35. In S350 the CPU 32 displays the content and number of address book records stored in the address book storage area 350 and subsequently quits the contact data management program according to the second embodiment.

Accordingly, when the CPU 32 determines that two or more address book records among the records received from the mobile telephone 2 via the transfer interface unit 50 and the records stored in the address book storage area 350 of the MFP 1 include common data entries, the CPU 32 combines data entries included in these duplicate records as a set and stores this set in the address book storage area 350 as a single address book record. Hence, the MFP 1 according to the second embodiment can effectively use the address book storage area 350 without needlessly increasing the number of address book records stored in the address book storage area 350, even when address book records are received from the address book storage area 550 of the mobile telephone 2.

Further, by avoiding a needless increase in the number of address book records stored in the address book storage area 350, the address book records are more easily managed.

While the invention has been described in detail with reference to first and second embodiments thereof, it would be apparent to those skilled in the art that many modifications and variations may be made therein without departing from the spirit of the invention, the scope of which is defined by the attached claims.

Rather than performing the process in S10 described in the first and second embodiments for prompting the user to specify a search condition for searching for duplicate records, the MFP 1 may be configured to skip this process and search for duplicate records based on all data types.

Further, while the contact data management programs according to the first and second embodiments are described separately, these programs may be combined for use in the MFP 1. Specifically, both a program used to combine duplicate records into a single address book record when searching for duplicate records stored on the MFP 1 and a program used to combine duplicate records into a single address book record when searching for duplicate records among address book records received from the mobile telephone 2 or another communication device and address book records stored on the MFP 1 may be stored in the ROM 33 of the MFP 1.

Further, while the MFP 1 receives address book records from the mobile telephone 2 via the transfer interface unit 50 and stores this data in the second embodiment, the present invention is not limited to this method, provided that the MFP 1 receives address book records from a device having at least a storage function. For example, the MFP 1 may receive address book records by reading data stored on a USB memory card or the like capable of being detachably connected to the MFP 1, or may receive address book records from a PC having a telephone function via a LAN.

Further, in the first and second embodiments described above, the MFP 1 combines data entries included in duplicate records to form a single new address book record. However, the MFP 1 may be configured to copy data entries included in one of the duplicate records to an available region in another duplicate record. Specifically, the MFP 1 can extract an data entry in one duplicate record that is unique to this record and copy this data entry to the other duplicate record, resulting in a single address book record having no duplicate entries.

Further, in the second embodiment described above, the MFP 1 stores address book records received from the mobile telephone 2 in the RAM 34 to be used in subsequent processing. However, the MFP 1 may first store the data in the address book storage area 350 of the MFP 1 and delete duplicate records in a subsequent process. In this case, the MFP 1 stores the address book records received from the mobile telephone 2 in a way that can differentiate the received records from address book records originally stored in the address book storage area 350, and can subsequently determine whether data entries in the records received from the mobile telephone 2 match data entries in the records originally stored in the address book storage area 350.

While the description in the second embodiment assumes that the address book records received from an external device are in the vCard file format, the MFP 1 may be configured to similarly search for duplicate records stored in another file format, such as the comma-separated values (CSV) file format or text file format.

What is claimed is:

1. A communication device comprising:
a storing section that is configured to store a plurality of communication contact data, each communication contact datum including a set of a plurality of data entries identifying a single communication contact;
a determining section that is configured to determine whether any two or more of the plurality of communication contact data stored in the storing section include common data entries; and
a storage controlling section that is configured to store the set of data entries included in the communication contact data determined to have common data entries in the storing section as a single communication contact datum when the determining section determines that there exists a plurality of communication contact data including common data entries.

2. The communication device according to claim 1, wherein the storage controlling section is configured to prevent the single communication contact datum from including duplicates of the same data entries when generating the single communication contact datum from a set of data entries included in each communication contact datum determined to have common data entries.

3. The communication device according to claim 2, wherein the storage controlling section comprises a reorganizing section that is configured to form a single communication contact datum from a set of the common data entries and data entries other than the common data entries included in each of the communication contact datum determined to include common data entries, and store the communication contact datum produced by the reorganizing section in the storing section while deleting the communication contact data determined to have the common data entries from the storing section.

4. The communication device according to claim 1, wherein the plurality of data entries included in the communication contact data is stored in categories based on data type,
the communication device further comprising:
an inputting section that inputs various instructions based on user operations; and
a recognizing section that is configured to recognize a data type specified by the user based on instructions inputted via the inputting section,
wherein the determining section determines whether any of the communication contact data includes common data entries for data entries stored based on the data type recognized by the recognizing section.

5. The communication device according to claim 1, wherein the determining section is configured to determine whether there exist communication contact data including common data entries after removing indecipherable symbols and special characters when the data entries included in the communication contact data include such indecipherable symbols or special characters.

6. The communication device according to claim 1, wherein, when the set of data entries included in communication contact data determined to have common data entries exceeds the number of data entries that can be included in a single communication contact datum, the storage controlling section is configured to store the communication contact data in the storing section after deleting some of the data entries included in the set constituting the communication contact data to adjust the number of data entries in the set.

7. The communication device according to claim 4, wherein the storage controlling section is configured to delete some of the data entries included in the set of data constituting the communication contact data based on user instructions inputted via the inputting section.

8. The communication device according to claim 1, further comprising an outputting section that is configured to output a list of data entries stored in the storing section by the storage controlling section as a single communication contact datum.

9. A communication device comprising:
a first storing section that is configured to store a plurality of communication contact data, each communication contact datum including a set of a plurality of data entries identifying a single communication contact;
a second storing section that is externally connected to the communication device;
an acquiring section that is configured to acquire the communication contact data stored in the second storing section;
a determining section that is configured to determine whether any two or more of the plurality of communication contact data acquired by the acquiring section and stored in the first storing section include common data entries; and
a storage controlling section that is configured to store the set of data entries included in the communication contact data determined to have common data entries in the first storing section as a single communication contact datum when the determining section determines that there exists a plurality of communication contact data including common data entries.

10. The communication device according to claim 9, wherein the storage controlling section is configured to prevent the single communication contact datum from including duplicates of the same data entries when generating the single communication contact datum from a set of data entries included in each communication contact datum determined to have common data entries.

11. The communication device according to claim 10, wherein the storage controlling section comprises a reorganizing section that is configured to form a single communication contact datum from a set of the common data entries and data entries other than the common data entries included in each of the communication contact datum determined to include common data entries, and store the communication contact datum produced by the reorganizing section in the first storing section while deleting the communication contact data determined to have the common data entries from the first storing section.

12. The communication device according to claim 9, wherein the plurality of data entries included in the communication contact data is stored in categories based on data type,
the communication device further comprising:
an inputting section that inputs various instructions based on user operations; and
a recognizing section that is configured to recognize a data type specified by the user based on instructions inputted via the inputting section,
wherein the determining section is configured to determine whether any of the communication contact data includes common data entries for data entries stored based on the data type recognized by the recognizing section.

13. The communication device according to claim 9, wherein the determining section is configured to determine whether there exist communication contact data including common data entries after removing indecipherable symbols and special characters when the data entries included in the communication contact data include such indecipherable symbols or special characters.

14. The communication device according to claim 9, wherein, when the set of data entries included in communication contact data determined to have common data entries exceeds the number of data entries that can be included in a single communication contact datum, the storage controlling section is configured to store the communication contact data in the first storing section after deleting some of the data entries included in the set constituting the communication contact data to adjust the number of data entries in the set.

15. The communication device according to claim 12, wherein the storage controlling section is configured to delete some of the data entries included in the set of data constituting the communication contact data based on user instructions inputted via the inputting section.

16. The communication device according to claim 9, further comprising an outputting section that is configured to output a list of data entries stored in the first storing section by the storage controlling section as a single communication contact datum.

17. A storage medium storing a contact data management program that has a set of program instructions executable on a computer of a communication device, the communication device including a storing section that is configured to store a plurality of communication contact data, each communication contact data including a set of a plurality of data entries identifying a single communication contact,
the set of program instructions comprising:
determining whether any two or more of the plurality of communication contact data stored in the storing section include common data entries; and
storing the set of data entries included in the plurality of communication contact data determined to have common data entries in the storing section as a single communication contact datum when it is determined that there exists a plurality of communication contact data including common data entries.

18. A storage medium storing a contact data management program that has a set of program instructions executable on a computer of a communication device, the communication device comprising:
a first storing section that is configured to store a plurality of communication contact data, each communication contact data including a set of a plurality of data entries identifying a single communication contact; and
a second storing section that is externally connected to the communication device,
the set of program instructions comprising:
acquiring the communication contact data stored in the second storing section;
determining whether any two or more of the plurality of communication contact data acquired and stored in the first storing section include common data entries; and
storing the set of data entries included in the communication contact data determined to have common data entries in the first storing section as a single communication contact datum when it is determined that there exists a plurality of communication contact data including common data entries.
